(19) United States
(12) Patent Application Publication
(10) Pub. No.: US 2002/0088166 A1
(43) Pub. Date: Jul. 11, 2002

(54) Fishing lure and apparatus for manufacture thereof

(76) Inventor: Howard Halsne, Palatinne, IL (US)

Correspondence Address: ROBERT A PAJAK, PATENT SERVICES, 14234 NAPLES STREET NE, HAM LAKE, MN, 55304

(21) Appl. No.: 09/758,731

(22) Filed: Jan. 11, 2001

(51) Int. Cl. A01K 91/00

(52) U.S. Cl. 43/44.9

(57) ABSTRACT

A jig-type fishing lure includes a lure head having a front portion and a rear portion. The rear portion of the lure head includes a lure head stem protruding therefrom. A substantially rigid interior tube member is provided longitudinally through the lure head from the front portion to the rear portion and through the lure head stem. A substantially flexible exterior tube member having a stem end and a fish hook receiving end is concentrically coupled in part to the lure head stem such that the interior tube member together with the exterior tube member form a passage way for a fishing line therethrough. The fishing line is coupled to an attachment eye portion of the fish hook. The fishing line is then pulled away from the lure such that the eye of the fish hook abuts the lure head stem. The exterior tube member securely holds the eye of the fish hook therewithin.

### FIELD OF THE INVENTION

The present invention relates generally to fishing lures, and specifically to jig-type fishing lures.

### BACKGROUND OF THE INVENTION

Jig-type fishing lures are useful in many angling activities. Generally, a jig-type lure is characterized by a ball- or conical-shaped lead housing or jig head that partially contains a shank portion of a single fish hook. An eye of the hook, formed by a loop in a top end portion of the shank, protrudes from the jig head so that a fishing line may be tied thereto. The shank portion of the hook is contained partially within the jig head, typically by way of forming or molding the jig head around the shank. Lead, or a lead alloy, is commonly chosen as a fabrication metal for the jig head molding so that the overall lure thus created has sufficient mass for sinking through water to a depth where fish may be feeding.

Of course, jig-type lures may be found in various shapes and sizes, depending upon fish to be caught and bodies of water to be fished. Inland lakes in the United States containing relatively small fish such as walleye, bass, and various “panfish” require use of small or lightweight jig-type lures that simulate small fish upon which these species feed. In contrast, trout and salmon in the Great Lakes of the central United States are much larger, heavier, and more aggressive in their feeding behavior, and therefore require larger and heavier type lures. Because of their size, heaviness, and resulting strength and resistance to being caught, Great Lakes trout and salmon may severely bend or break a fish hook of a jig-type lure, thereby rendering the lure useless. Significant cost may be incurred in continually replacing lures so damaged while fishing for these Great Lakes species.

In attempts to improve jig-type lures, alternatives have been proposed to the aforedescribed conventional lure. Examples of these alternative jigs are disclosed in U.S. Pat. No. 4,163,337 entitled “Fishing Lure” issued to Kress, and in U.S. Pat. Nos. 4,837,966 and 4,965,956 each entitled “Cam Action Fishing Sinker Device” and issued to Bethel. The Kress patent discloses a lure having an elongated housing or jig head that defines therein a housing void for receiving a shank section of a fishing hook. A small bore is provided through a front end of the head into the housing void for allowing a fishing line to pass therethrough. However, in this lure, the head may become disengaged or separated from the hook by sliding away from the hook along the fishing line, consequently leaving an appearance of a bare hook that is not likely to attract fish.

The aforementioned Bethel patents disclose a sinker device that may slide away from a fish hook (as in the Kress patent). The Bethel patents teach holding the sinker in engagement with the hook by way of compression of the sinker about eye and shaft portions of the hook. Such compression, however, may permanently deform the lure, leading to overall weakness of the lure.

U.S. Pat. No. 5,535,540 issued to Crumrine entitled “Jigging System Apparatus” discloses a mechanical hook locking device for releasably engaging an eye of a fish hook therewithin.

U.S. Pat. No. 5,899,015 issued to Link entitled “Fishing Jig With Recessed Skirt” discloses a jig or sinker head having a recessed portion for accommodating a hook eye therewithin.

Lures exemplified by the above patents have several disadvantages. Chief among these are that such lures are relatively complex in their construction. Also, the head portion of some lures may, in use, slide away from the hook prematurely and thereby diminish “realism” of the lure in attracting fish. Further, a fishing line coupled to such a lure may become frayed by an action of the lure head sliding along the line, consequently weakening the line. Additionally, as aforementioned, compressing a lure or sinker body may lead to permanent deformation of the body rendering the lure unsuitable for future use.

Thus, there exists a need for a jig-type lure that is inexpensive and simple to fabricate, that has a head that does not tend to slide away from the hook, and that does not fray or otherwise damage a fishing line tied thereto. Further, such a lure is needed that does not require compression and deformation in attachment to a fish hook.

### SUMMARY OF THE INVENTION

An object of the present invention is to provide a jig-type fishing lure that is inexpensive and simple to fabricate.

Another object of the present invention is to provide a jig-type fishing lure having a head that does not tend to slide away from a hook.

A further object of the present invention is to provide a jig-type fishing lure that does not fray fishing line tied thereto.

A still further object of the present invention is to provide a jig-type fishing lure that does not require compression and deformation in attachment to a hook.

In accordance with the present invention, a jig-type fishing lure includes a lure head having a front portion and a rear portion. The rear portion of the lure head includes a lure head stem protruding therefrom. A substantially rigid interior tube member is provided through the lure head from the front portion to the rear portion and through the lure head stem. A substantially flexible and gripping exterior tube member having a stem end and an opposing fish hook receiving end is coupled to the lure head stem such that the interior tube member together with the exterior tube member form a passage way for a fishing line therethrough. The fishing line, having been passed through the tube members, is then coupled to an eye portion of the fish hook. The fishing line is then pulled away from the front portion of the lure head such that the eye of the hook is received within the gripping exterior tube member and then abuts the lure head stem and the interior tube member. The exterior tube member also provides secure positioning of the eye portion of the fish hook therewithin.

### BRIEF DESCRIPTION OF THE DRAWINGS

FIG. 1 is a magnified side view illustration of a fishing lure constructed in accordance with the present invention.

FIG. 2 is a magnified and partially transparent illustration of a portion of the fishing lure shown in FIG. 1.

FIG. 3 is a magnified illustration of the fishing lure shown in FIG. 1, depicting preparation for use.

FIG. 4 is an illustration of an apparatus for manufacturing the fishing lure of the present invention, depicted in an open condition.

FIG. 4a is a top view illustration of the apparatus shown in FIG. 4, depicting a closed condition.

FIG. 5 is a magnified illustration of the fishing lure shown in FIG. 1, further including a weed guard.

FIG. 6 is a magnified illustration of the fishing lure shown in FIG. 1, including a decorative skirt.

### DETAILED DESCRIPTION OF THE INVENTION

In the following exposition, the words “lure” and “jig” may be taken as synonymous, and are intended to include any jig-type fishing lures.

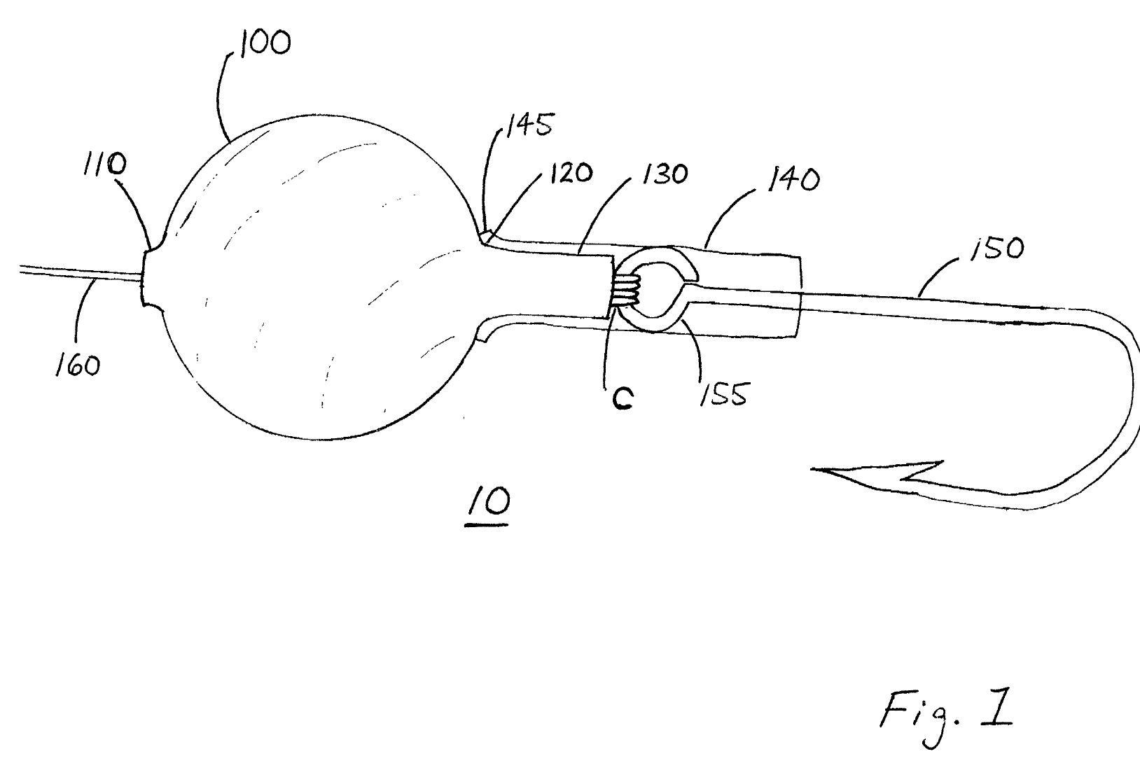

Referring to FIG. 1, thereshown is a side view illustration of an exemplary embodiment of a fishing lure 10 of the present invention.

In FIG. 1, fishing lure 10 includes a generally ball or spherically shaped lure head 100. Lure head 100, in turn, includes a front portion 110 and a rear portion 120, a substantially cylindrical stem 130 protruding from rear portion 120, and an exterior tube member 140 concentrically coupled to a portion of stem 130. The concentric coupling of exterior tube member 140 to stem 130 is provided such that a front end 145 of tube member 140 may fit tightly against rear portion 120 of lure head 100.

Lure head 100 (including front portion 110, rear portion 120, and stem 130) is preferably cast or molded from a relatively high-mass metal such as lead. External tube member 140 may be fabricated from, for example, a durable clear plastic or vinyl tubing material. Such material for tube member 140 is preferably chosen for properties of flexibility and gripping ability relative to stem 130 and to an eye of a fish hook received therein (as further described below).

Also shown in FIG. 1 are a conventional barbed fish hook 150 having a fishing line attachment eye 155, and a fishing line 160 tied, knotted, or otherwise coupled to eye 155 of fish hook 150 (generally indicated by reference character “C”) as will be further described.

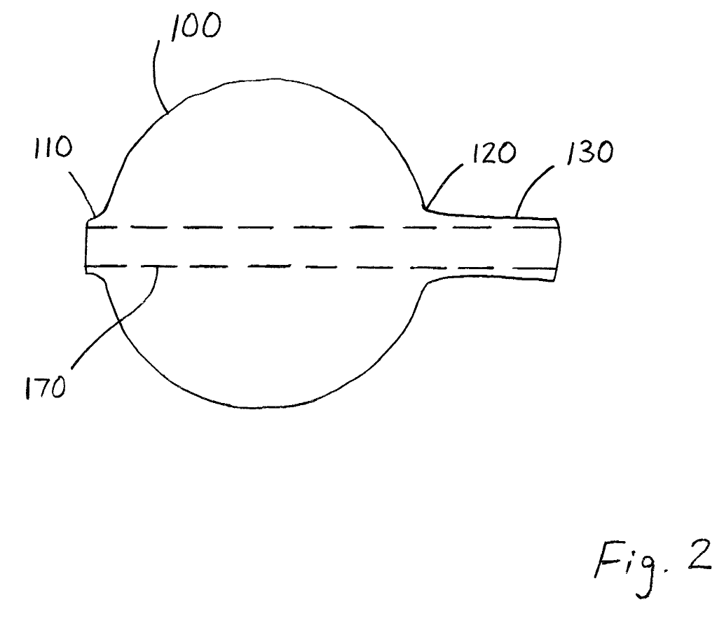

Turning, now, to FIG. 2, lure head 100 is shown with the aforementioned components of exterior tube member 140, fish hook 150, and fishing line 160 removed from the drawing for clarity thereof. A generally cylindrical interior tube member 170 (not depicted in FIG. 1) is provided longitudinally within and through lure head 100, including front portion 110 and rear portion 120, and stem 130. Interior tube member 170 provides a passage-way for fishing line 160 through lure head 100 and stem 130, and is substantially concentric therewith. Interior tube member 170 is preferably provided by a hard plastic tubing material of sufficient length and interior diameter to accommodate fishing line 160 passing therethrough and located therewithin, without frictional interference occurring between line 160 and tube member 170.

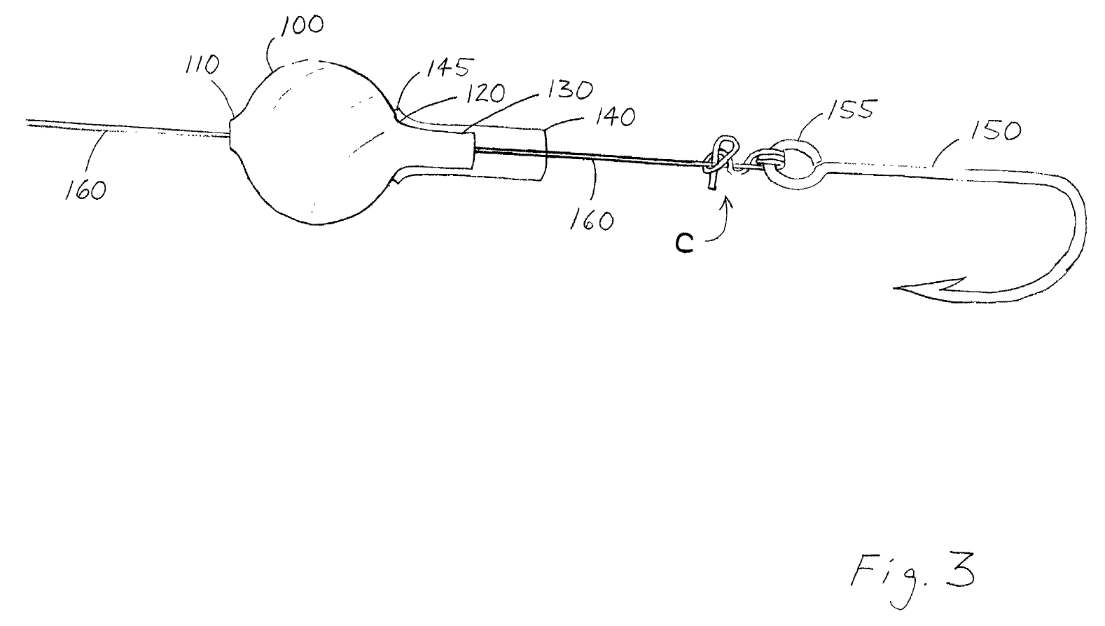

Referring to FIG. 3, lure 10 is shown as being prepared for use. Specifically, fishing line 160 is passed or “threaded” through lure head 100 (from front portion 110 to rear portion 120) by way of passage through interior tube member 170, and then through a remaining portion of exterior tube member 140. A sufficient length of fishing line 160 is passed through the aforementioned components to facilitate knotting, tying, or otherwise coupling (denoted by reference character C) fishing line 160 to eye 155 of hook 150. Coupling C may also be achieved by way of, for example, a conventional snap-swivel leader tied to line 160 and then snapped into eye 155.

With hook 150 so coupled (C) to line 160, line 160 is then pulled outwardly from front portion 110 of lure head 100 (to the left in FIG. 3) such that coupling C and eye 155 are held firmly in abutting position against stem 130 (as shown in FIG. 1). In this arrangement, a frictional fit exists between flexible and gripping exterior tube member 140 and eye 155 for additional positional security of hook 150 with lure head 100.

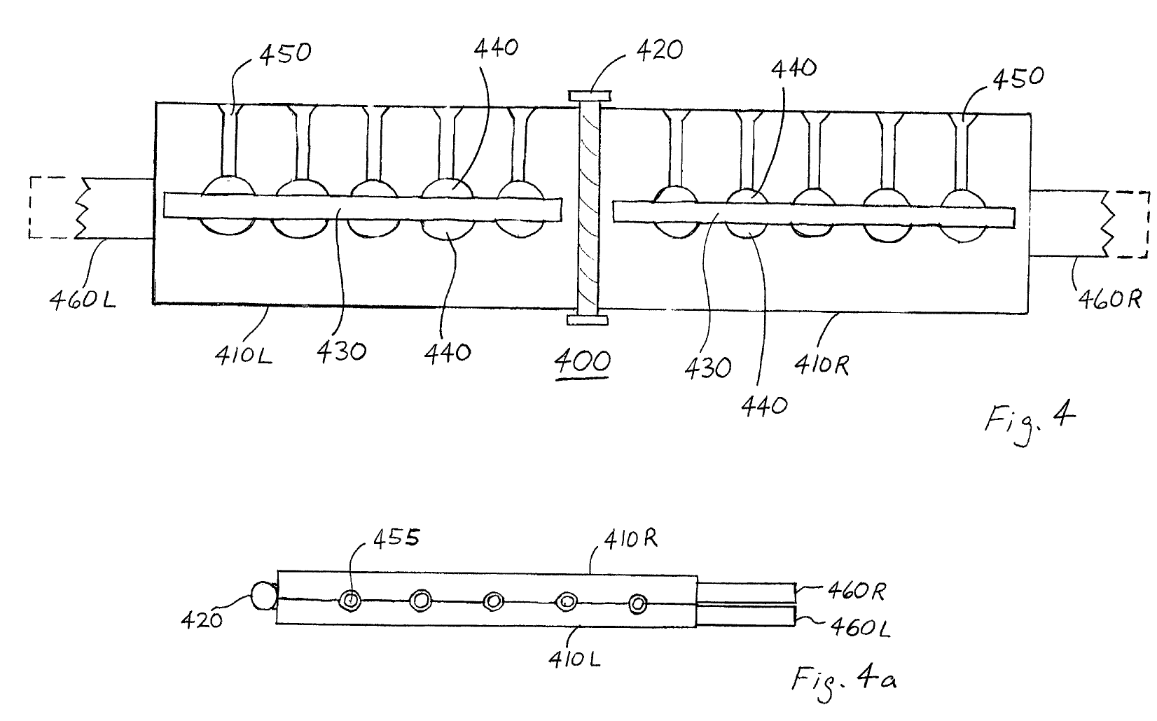

With reference, now, to FIG. 4, an apparatus for manufacture of lure 10 will be discussed.

In the figure, a lure mold 400 includes a pair of complimentary left and right mold halves 410L and 410R, respectively, rotatably joined by hinge 420. It is to be understood that left and right mold halves 410L-R are essentially “mirror images” of each other.

Mold halves 410L-R each include complimentary longitudinal channel halves 430, a series of complimentary lure head chamber halves 440, and a series of complimentary filling riser halves 450. In the exemplary FIG. 4, ten lure head chamber halves 440 are depicted for fabrication, accordingly, of five lure heads 100.

In the exemplary embodiment, mold halves 410L-R further include handle members 460L and 460R, respectively.

In preparation for molding a series of lure heads 100, an uncut length of interior tube member 170 is placed in a selected one of channel halves 430 of mold halves 410L-R.

The diameters of channel halves 430 and interior tube member 170 are preferably chosen to nearly match each other. Likewise, the length of interior tube member 170 is chosen to nearly match the length of each of channel halves 430. Thus, when molten metal is poured into and flows throughout mold 400 (as will be further described) the flowing metal may fully surround interior tube member 170 thereby encasing it within lure head chamber halves 440.

With interior tube member 170 placed in either of mold halves 410L or 410R, halves 410L-R are brought together about hinge 420, thereby forming a closed mold 400 (as depicted in FIG. 4a). Mold 400 then may be manipulated by a user by way of handle members 460L-R having also been brought together upon the closing of mold 400, to form an overall unitary handle.

It is to be appreciated that by a user firmly grasping the unitary handle formed by handle members 460L-R, mold 400 may securely remain in a closed condition. With mold 400 thus closed, molten metal (preferably, lead) is then carefully poured into any number of risers 455 (FIG. 4a) formed by riser halves 450 (FIG. 4) until the metal is observed to have filled each riser 455, thereby ensuring that all lure head chamber halves 440 and channel halves 430 have been filled with the metal (except, of course, where interior tube member 170 is located within channel halves 430). It is to be particularly understood that channel halves 430 provide for a flow of molten metal throughout mold 400, since channel halves 430 function to effectively transport the molten metal between lure head chamber halves 440 upon introduction of the metal at selected filling risers 455.

After the molten metal poured into mold 400 has sufficiently cooled and hardened, mold 400 is opened by releasing handle members 460L-R. With mold 400 opened, a series of connected lure heads 100 are obtained, being joined in series together by interior tube member 170 secured longitudinally through each head 100.

Interior tube member 170 is then cut between each lure head 100, thereby resulting in a collection of separate lure heads 100. Columns of metal protruding substantially perpendicularly to tube member 170 from each lure head 100, corresponding to risers 455, are cut off or ground away from heads 100. Further cutting, grinding, and polishing procedures may be employed to obtain heads 100 that are preferably configured as shown in FIG. 2.

As would be understood by those skilled in molding arts, any equal number of lure head chamber halves 440, and corresponding filling riser halves 450 and corresponding lengths of channel halves 430, may be provided in a given mold 400 as may be desired for mass molding production of lure heads 100.

While the present invention has been particularly shown and described with reference to the accompanying figures, it will be understood, however, that other modifications thereto are of course possible, all of which are intended to be within the true spirit and scope of the present invention. It should be appreciated that components of the invention aforedescribed may be substituted for other suitable components for achieving desired similar results, or that various accessories may be added thereto.

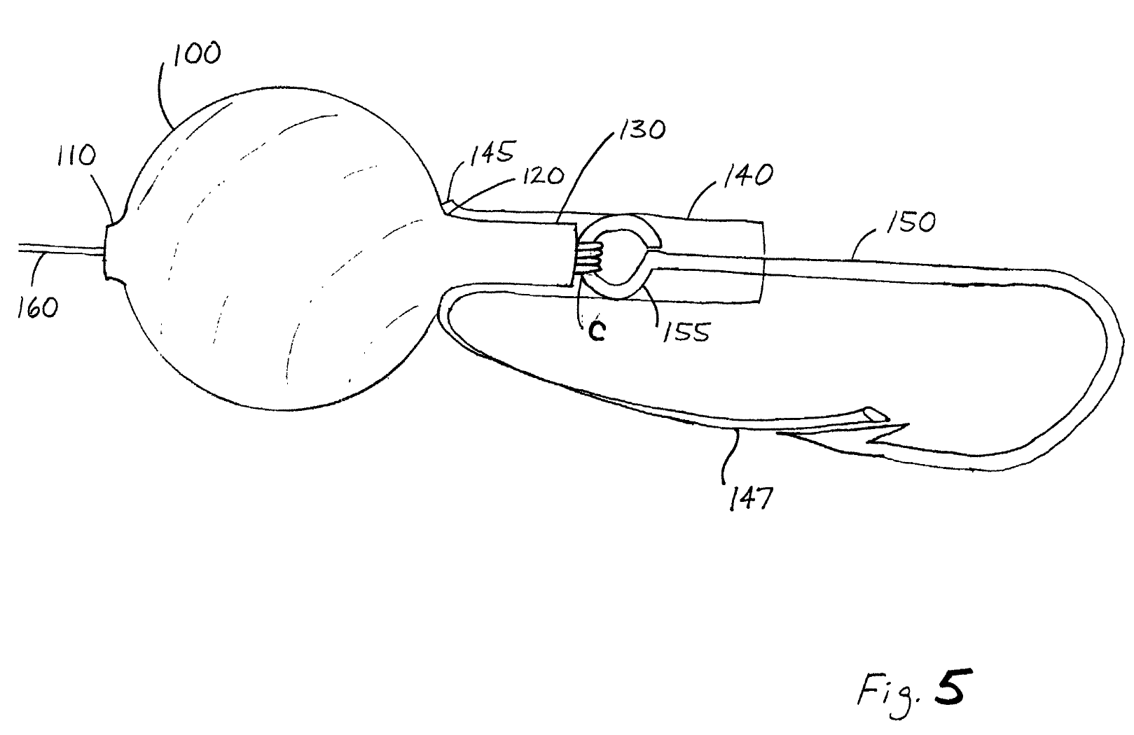

For example, FIG. 5 depicts a weed guard 147 fashioned from an extruding portion of front end 145 of exterior tube member 140. Herein, “weed” is intended to include any aquatic plant or other matter that may interfere with or otherwise foul hook 150, as recognized by anglers. As may be ascertained from the figure, weed guard 147 effectively covers or guards the barbed end of hook 150, such that weeds are prevented from accumulating on or adhering to the barbed end of hook 150. Because weed guard 147 is fashioned from the flexible material integral to tube member 140, weed guard 147 does not inhibit the catching of a fish by the barbed end of hook 150.

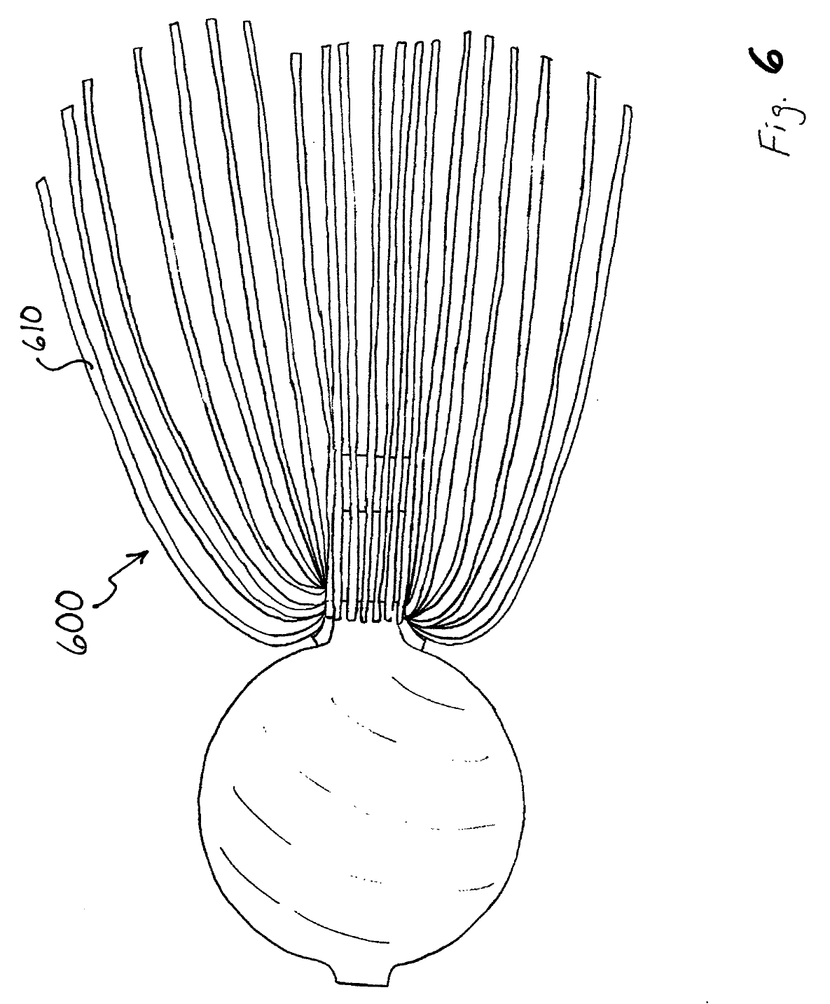

Also, FIG. 6 depicts a decorative skirt 600 giving lure 10 an appearance of a “fly” or a “squid”. Decorative skirt 600 may include a plurality of individual streamers 610 that are secured to external tube member 140 by way of, for example, a collar member (not illustrated) that is glued, taped, or otherwise affixed to exterior tube member 140. Streamers 610 are preferably colored to attract fish; for example, streamers 610 may be various shades and hues of bright or fluorescent blue, green, or orange, or may even be “rainbow” colored, depending upon which colors have been observed to attract fish at a given location and depth in a particular lake.

Additionally, decorative eyes (not illustrated) could be pasted, glued, or otherwise adhered to lure head 100 to give a more realistic appearance of a baitfish, fly, or squid, thereby increasing chances of angling success.

It is to be understood that any suitable alternatives may be employed to provide the fishing lure of the present invention, along with its manufacturing apparatus.

For example, a flexible metal “finger” member could be substituted for weed guard 147 described as formed by the flexible extruding portion of external tube member 140.

Also, for example, a unitary cone-shaped member, fashioned from plastic sheet material or the like, could be substituted for streamers 610 of skirt 600.

Further, handle members 460L-R could be removed from mold 400, if they are found to be unnecessary by alternatively placing the closed mold 400 into a fixed holding or clamping device such as a vise.

Lastly, the choice, of course, of mechanical sizes and strengths of various aforementioned components of lure 10 are all a matter of design choice depending upon intended uses of the present invention.

Accordingly, these and other various changes or modifications in form and detail of the present invention may also be made therein, again without departing from the true spirit and scope of the invention as defined by the appended claims.

What is claimed is:

1. A fishing lure comprising:
a lure head having a front portion and a rear portion, wherein said rear portion of said lure head includes a lure head stem protruding therefrom;
an interior tube member longitudinally provided through said lure head, from said front portion to said rear portion, and longitudinally through said lure head stem, said interior tube member being substantially rigid; and
an exterior tube member having a stem end and a fish hook receiving end, said stem end of said exterior tube member being substantially concentrically coupled to said lure head stem, with said exterior tube member being substantially flexible so that a fishing line attachment eye of a fish hook may be securely held therewithin, and with said eye of said fish hook abutting said lure head stem,
wherein said interior tube member and said exterior tube member form a substantially longitudinal passage way for passage of a portion of a fishing line therethrough for coupling to said eye of said fish hook.

2. The fishing lure of claim 1, wherein said exterior tube member includes at least one elongated portion thereof projecting from said stem end to a vicinity of a barbed end of said fish hook, thereby forming a weed guard for prevention of weed accumulation on said fish hook.

3. The fishing lure of claim 1, further including a decorative skirt coupled to said exterior tube member, said skirt having at least one streamer projecting therefrom, such that said skirt is capable of covering, at least in part, said fish hook.

4. An apparatus for manufacturing a fishing lure, comprising:
a lure mold, said lure mold including (i) a left mold half having a left end and a right end, and (ii) a right mold half, being substantially a mirror image of said left mold half, said right mold half having a left end and a right end;
a hinge joining said left mold half and said right mold half, said hinge being coupled to said right end of said left mold half, and to said left end of said right mold half;
a first channel longitudinally provided in said left mold half between said left and right ends thereof, and a second channel being substantially a mirror image of said first channel, said second channel further being longitudinally provided in said right mold half between said left and right ends thereof;
at least one first lure head chamber provided within said left mold half in communication with said first channel, and at least one second lure head chamber being substantially a mirror image of said at least one first lure head chamber, said at least one second lure head chamber further being provided within said right mold half in communication with said second channel; and
a first filling riser channel in communication with, respectively, each of said at least one first lure head chamber, and a second filling riser channel in communication with, respectively, each of said at least one second lure head chamber and being substantially a mirror image of said first filling riser channel, where said first filling riser channel and said second filling riser channel, upon being brought into contiguous juxtaposition, together form a filling riser,
wherein upon closing said mold by bringing together said left mold half and said right mold half about said hinge into contiguous juxtaposition with each other, molten metal may be poured into said mold by way of said filling riser.

5. The apparatus for manufacturing a fishing lure of claim 4, further including a first handle member coupled to said left mold half proximate to said left end thereof, and a second handle member coupled to said right mold half proximate to said right end thereof.
